(19) United States
(12) Patent Application Publication
(10) Pub. No.: US 2014/0370613 A1
(43) Pub. Date: Dec. 18, 2014

(54) Atmospheric Pressure Chemical Ionization Detection

(71) Applicant: Waters Technologies Corporation, Milford, MA (US)

(72) Inventor: Douglas M. Stevens, Holden, MA (US)

(73) Assignee: Waters Technologies Corporation, Milford, MA (US)

(21) Appl. No.: 14/365,154

(22) PCT Filed: Dec. 10, 2012
(86) PCT No.: PCT/US12/68663

§ 371 Date: Jun. 13, 2014

Related U.S. Application Data
(60) Provisional application No. 61/570,442, filed on Dec. 14, 2011.

(51) Int. Cl. G01N 27/70

(52) U.S. Cl. CPC G01N 27/70
USPC 436/153; 422/98

(57) ABSTRACT

An atmospheric pressure chemical ionization detector includes a reaction chamber that is configured to receive gas phase analytes. An electrode is disposed within the reaction chamber and is configured to ionize the gas phase analytes via corona discharge. A collector is disposed adjacent an outlet of the reaction chamber and is configured to attract ions from the chamber such that the ions hit the collector to induce a measurable current. The detector is configured for non-mass spectrometric detection of gas phase analyte ions.

### RELATED APPLICATION

This application claims priority to and benefit of U.S. Provisional Patent Application No. 61/570,442, entitled “Atmospheric Pressure Chemical Ionization Detection,” filed Dec. 14, 2011, which is incorporated by reference herein in its entirety.

### TECHNICAL FIELD

This disclosure relates to atmospheric pressure chemical ionization detection.

### BACKGROUND

In gas chromatography, a flow of a mobile phase gas (or “carrier gas”), typically an inert gas, sweeps a sample through a gas chromatography column. Generally, the column includes a layer of polymer or liquid that acts as a stationary phase. The sample is separated into its constituent parts (i.e., separate compounds) as it passes through the column and interacts with the stationary phase material. As a result, the various compounds that make up the sample elute from the column at different times.

Often, a detector is employed to monitor the effluent from the column, which can allow the separated compounds to be identified based on the order in which they elute from the column and the time it takes for them to pass through the column (“retention time”). Various detectors have been employed for gas chromatography including flame ionization detectors (FIDs) and mass spectrometers.

Typically, in FIDs, effluent from a gas chromatography column is mixed with a fuel (e.g., hydrogen gas) and an oxidant (e.g., air), and the mixture is then passed through a flame. Combustion of gases in the flame generates ions. The ions are repelled by a first electrode toward a second electrode (“collector plate”). The ions create a current between the electrodes and the remaining gaseous products are vented through an exhaust. FIDs are known for their sensitivity to hydrocarbons. However, FIDs are generally only useful for detecting components that can be burned. In addition, the use of combustible fuel in these detectors can be disadvantage due to the explosion hazard it presents.

In the case of mass spectrometers, effluent from a gas chromatography column is passed through an ion source to convert gas phase molecules into ions. The ions then pass through a mass analyzer where they are sorted by their respective masses. The sorted ions are then sent to a detector, which records either a charge induced or a current produced when ions pass by or hit a surface.

### SUMMARY

One aspect provides an atmospheric pressure chemical ionization detector that includes a reaction chamber that is configured to receive gas phase analytes. An electrode is disposed within the reaction chamber and is configured to ionize the gas phase analytes via corona discharge. A collector is disposed adjacent an outlet of the reaction chamber such that the ions hit the collector to induce a measurable current. The detector is configured for non-mass spectrometric detection of gas phase analyte ions.

Another aspect features a method that includes passing a flow of a first gas carrying a sample through a gas chromatograph; merging a flow of a second gas with effluent from the gas chromatograph to provide a mixed gas flow; generating ions by passing the mixed gas flow through a corona discharge; and measuring a cumulative ion intensity of the generated ions without passing the ions through a mass analyzer.

Yet another aspect provides a method that includes passing a flow of a first gas carrying a sample through a gas chromatograph; merging a flow of a second gas with effluent from the gas chromatograph to provide a mixed gas flow; generating ions by passing the mixed gas flow through a corona discharge; and measuring a cumulative ion intensity of the generated ions without separating the ions according to their respective mass-to-charge ratios.

According to another aspect, a method includes passing a flow of a first gas carrying a sample through a gas chromatograph; merging a flow of a second gas with effluent from the gas chromatograph to provide a mixed gas flow; generating ions by passing the mixed gas flow through a corona discharge; and performing non-mass spectrometric detection of the generated ions.

Implementations may include one or more of the following features.

In some implementations the detector also includes a base that is disposed upstream of the reaction chamber and is configured to direct a flow of a make up gas towards the reaction chamber.

In certain implementations, the base can be integrally connected to the reaction chamber.

In some cases, the base includes a heater for heating the effluent from the gas chromatography column.

In some implementations, the base is configured to be connected to an inlet tube for delivering effluent, containing the gas phase analytes, from a gas chromatography column.

In certain implementations, the electrode is mounted through a wall of the housing with an insulator.

In some implementations, the collector is a cylindrical electrode.

In some cases, the collector includes an exhaust port for venting neutral molecules.

In some implementations, the detector includes a variable restrictor or a pump in communication with the exhaust port for controlling pressure and/or gas concentration within the detector.

In certain implementations, the detector is configured to measure cumulative ion intensity, rather than individual ion intensities.

In some implementations, the detector is sensitive to the mass of ions (rather than the concentration of ions), such that the detector is not greatly affected by changes in carrier gas flow rate.

In some cases, the steps of generating ions and measuring a current are performed at a pressure approximately equal to atmospheric pressure.

In certain implementations, the effluent is heated to a temperature of about 50° C. to about 400° C.

In some implementations, the step of measuring a cumulative ion intensity includes measuring a current induced by ions hitting a collector electrode.

In certain implementations, the step of measuring a cumulative ion intensity includes measuring a total current of ions generated.

In some cases, the polarity of a corona pin generating the corona discharge is rapidly switched, thereby to detect ions having opposite polarities.

In some implementations, the polarity of the corona pin is switched at a frequency of about 50 Hz.

In certain implementations, corona discharge is provided by a corona pin disposed within a reaction chamber.

Implementations can provide one or more of the following advantages.

In some implementations, detection of analytes (e.g., analytes eluting from a gas chromatography column) is provided without the need for hydrogen as a fuel gas, which can present an explosion hazard.

In certain implementations, detection of ionized gas phase analytes is achieved via a simple collector electrode, without the use of a mass spectrometer.

Some implementations provide for the detection of a wide range of analytes similar to the range and types detected using chemical ionization with GC/MS, but with the need of a mass spectrometer.

Gas phase analytes are ionized without having to burn the analytes or pass the analytes through a flame.

In some implementations, ionization and detection of gas phase analytes is performed at atmospheric pressure.

In certain implementations, a detector is provided which can allow for testing at lower cost, using less space, and by users of lower expertise levels as compared to mass spectrometry based alternatives.

In some cases, a total current of ions formed is measured rather than individual ion intensities. Consequently, fragmentation resulting from some ionization modes is not an issue as it is with mass spectrometry (MS) based detection. Further, since the cumulative ion intensity is measured, sensitivity may be improved over MS based detection.

Other aspects, features, and advantages are in the description, drawings, and claims.

### BRIEF DESCRIPTION OF THE DRAWINGS

FIG. 1 is a schematic view of a gas chromatography system that includes an atmospheric pressure chemical ionization detector (APCID).

FIG. 2 is a schematic view of the atmospheric pressure chemical ionization detector of FIG. 1.

FIG. 3 is a schematic view of another implementation of the gas chromatography system including a flow restrictor at the exhaust of the APCID.

FIG. 4 is a schematic view of another implementation of the gas chromatography system including a pump at the exhaust of the APCID.

FIG. 5 is a schematic view of an atmospheric pressure chemical ionization detector of including a filter element that is arranged between a reaction chamber and a collector to reduce low mass chemical noise.

FIG. 6 is a schematic view of another implementation of a gas chromatography system that includes an atmospheric pressure chemical ionization detector (APCID) and a single gas source for providing both make up and carrier gas flows.

Like reference numbers indicate like elements.

### DETAILED DESCRIPTION

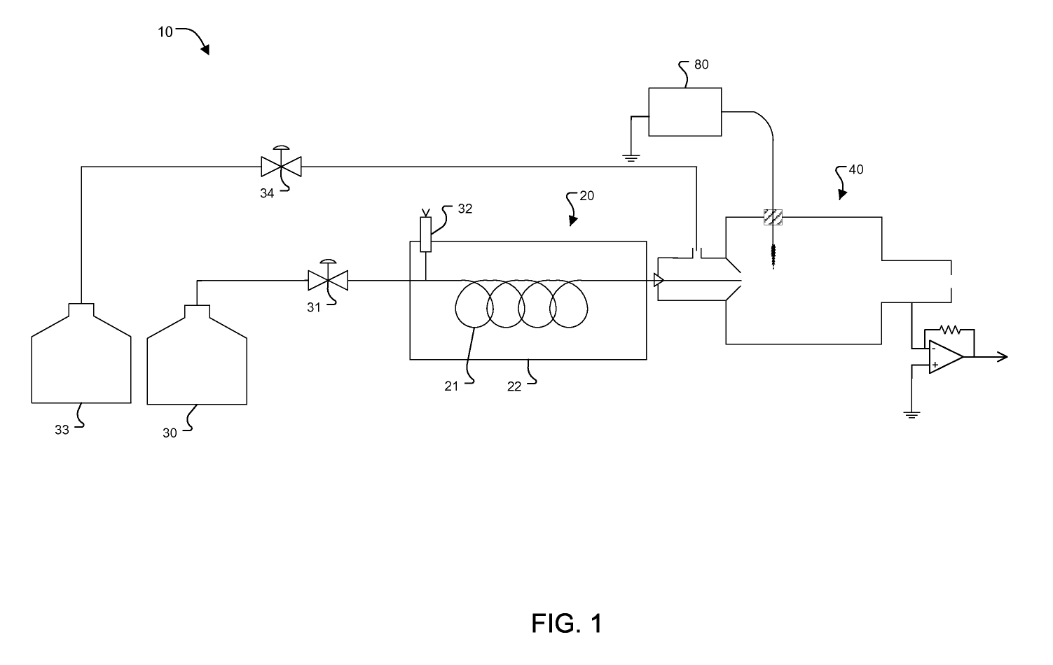

Referring to FIG. 1, a chromatography system 10 includes a gas chromatograph 20 and an atmospheric pressure chemical ionization detector (APCID) 40. The gas chromatograph 20 includes a gas chromatography (GC) column 21 that is disposed within a temperature controlled oven 22. The GC column 21 is a coil of metal, glass or fused silica capillary tubing, typically 0.53 mm or smaller internal diameter and 0.8 mm or smaller outside diameter, internally coated with a stationary phase suitable for effecting separation of different chemical components of a sample.

A first gas source (carrier gas source 30) is configured to provide a flow of a carrier (mobile phase) gas to the GC column 21. A first flow controller 31 is provided to maintain a constant flow of the carrier gas. A sample injector 32 is configured to introduce a sample containing analyte into the flow of carrier gas for introduction into the GC column.

A second gas source (make up source 33) provides a flow of a make up gas to the APCID 40 where it is to merge with effluent from the GC column 21. A second flow controller 34 is provided for maintaining the flow of the make up gas. The make up gas serves to help sweep the effluent from the GC column 21 through the APCID 40.

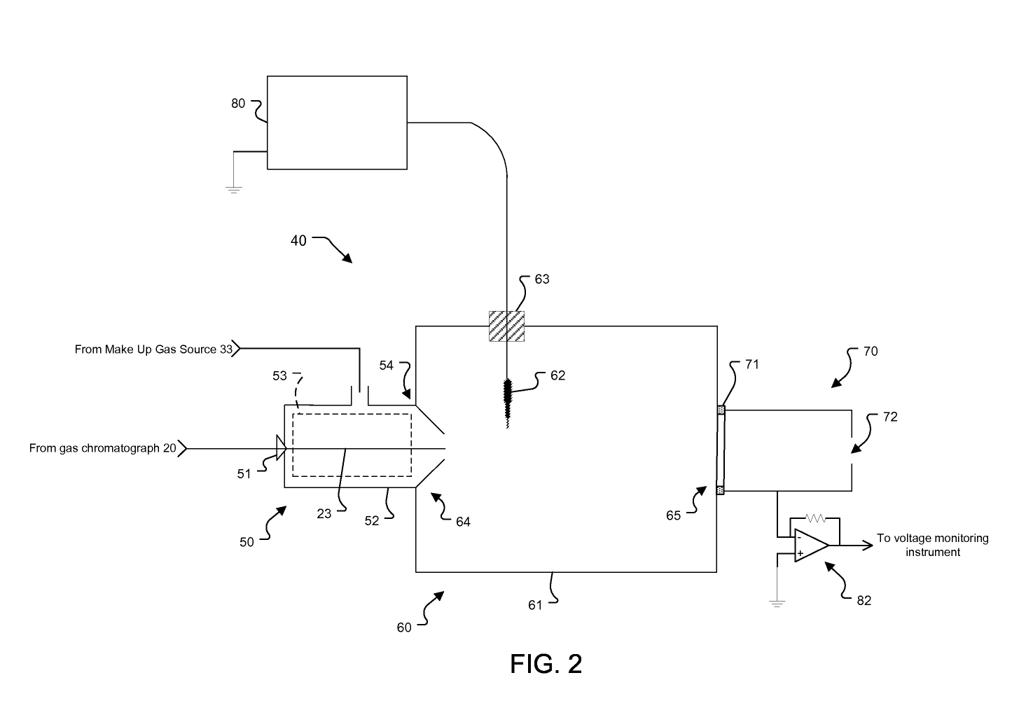

Referring to FIG. 2, the APCID 40 includes a base 50, an reaction chamber 60, and a collector 70. An inlet tube 23 is either integral with, or is connected to, an outlet of the GC column 21. For example, the inlet tube 23 may be a distal end portion of the GC column 21. Alternatively, the inlet tube 23 may be a fused silica tube connected to the distal (outlet) end of the GC column 21. The inlet tube 23 extends through a wall of the oven 22 and into the base 50 of the APCID 40. The base 50 connects to the inlet tube 23 via a standard fitting 51 sealing the inlet tube 23 to the APCID 40 using a ferrule. The base 50 includes an enclosure 52 that surrounds the inlet tube 23, and a heater 53. The enclosure 52 can be formed of a metal or metal alloy, such as stainless steel. The enclosure 52 can have a cylindrical shape with an inlet opening for connection with the inlet tube 23 and an outlet opening for delivering the make up gas and effluent into the reaction chamber 60. The enclosure 52 has an internal volume that is large enough to accommodate the inlet tube 23 without substantially restricting flow of the make up gas.

The heater 53 can be a cartridge heater disposed within the enclosure 52. Alternatively or additionally, the heater 53 can include a coiled resistance wire or tape heater wrapped about the enclosure 52. The heater 53 is capable of maintaining the temperature of the inlet tube 23 sufficiently high to prevent loss of analyte molecules as they travel from the base 50 into the reaction chamber 60. The necessary temperature is dependent on the nature of the analyte molecules, but may typically be in the range of about 50° C. to about 400° C. The reaction chamber 60 includes a housing 61 and a first electrode (corona pin 62) that is mounted through a wall of the housing 61 in an insulator 63, which electrically isolates the corona pin 62 from the housing 61. The housing 61 defines an inlet 64 and an outlet 65 and can be formed of a metal or metal alloy. In some cases, the housing 61 can be integral with the base 50. For example, the housing 61 and the base 50 can be machined as a single piece, or can be welded together to form an integral part. Alternatively, the housing 61 can connected to the distal end portion 54 of the base 50 via a threaded connection. For example, the base 50 can include a threaded outer surface that mates with a thread along the inlet 64 of the housing 61.

The collector 70 is a cylindrical electrode formed of an electrically conductive material such as a metal or metal alloy, e.g., stainless steel. The collector 70 is mounted adjacent the outlet 65 of the reaction chamber 60. An insulator 71 can be positioned between the collector 70 and the reaction chamber 60 to electrically isolate the collector 70. The collector 70 is configured to attract ions from the reaction chamber for detection. The collector 70 also includes an exhaust 72 for venting remaining gases, including neutral species and ions having polarity that is the same as that of the collector 70, out of the APCID 40.

A power supply 80 is connected to the corona pin 62 for providing a high voltage (e.g., about 5 kV) and an applied current of about 0.5 μA to about 50 μA (e.g., about 2 μA to about 5 μA) thereto. The power supply 80 can be a high voltage power supply (e.g., 6 kV, 50 μA) capable of reversing the output polarity (e.g., within milliseconds).

In some cases, the collector 70 can be electrically connected to the inverting input of a virtual ground 82. The virtual ground 82 can be provided by a current amplifier, such as the Model 428 current amplifier available from Keithley Instruments, Inc., Cleveland, Ohio. The output of the virtual ground can be connected to a voltage monitoring instrument (e.g., an A/D converter), which, in turn, can provide a corresponding signal to a computing system for analysis and display.

In use, a flow of carrier gas (e.g., helium (He)) is delivered at a flow rate of about 0.5 ml/min to about 10 ml/min to the GC column 21 from the carrier gas source 30. A sample containing analyte is introduced into the flow of carrier gas, which carries the sample into the GC column 21. The sample is separated into different chemical components (including analyte molecules) as it passes through the GC column 21.

The effluent from the GC column 21 passes into the APCID 40. A supply of make up gas (e.g., nitrogen (N₂) or helium (He)) from the second gas source 33 is delivered to the APCID 40 via a gas inlet 54 (FIG. 2) in the base 50. The make up gas is delivered at a flow rate sufficient to cause the effluent (carrier gas and analyte mixture) to be swept out of the base 50 and into the reaction chamber 60 on a chromatographic time scale. The make up gas flows in an annular space between the inside of the enclosure 52 and the exterior of the inlet tube 23 and exits through the distal end portion 54 of the base 50, where it merges with the effluent from the GC column 21. The base 50 is heated, via the heater 53, to a temperature of about 50° C. to about 400° C. to help ensure that as the effluent exits the GC column 21 it does not come out of the gaseous phase.

The effluent/make up gas mixture continues to travel into the reaction chamber 60. The reaction chamber 60 is heated, via the heater 53 in the base 50, to help ensure that as the effluent exits the GC column 21 it does not come out of the gaseous phase. Analyte molecules present in the reaction chamber 60 are ionized through atmospheric pressure chemical ionization. The pressure in the reaction chamber 60 is approximately equal to atmospheric pressure (e.g., about 980 millibars (mb) to about 1050 mb), and ionization is effected through a corona discharge. The corona pin 62 is held at a high voltage (e.g., about 5 kV), and a current of 0.5 μA to about 50 μA is applied to the corona pin 62 via the power supply 80, within the reaction chamber 60 and creates a plasma which leads to ionization of the analyte molecules.

The ionization may take place through a variety of mechanisms including charge transfer, protonation, hydride abstraction, electron capture, dissociative electron capture, deprotonation, and anion attachment. Varying conditions such as the gases within the cell and the polarity and magnitude of the voltage or current applied to the corona pin 62 control these processes resulting in different selectivity/specificity as well as sensitivity. For example, N₂ or He can be employed as the make up gas to promote charge exchange. Hydrogen gas (H₂) or doped N₂ can be employed as the make up gas to promote protonation. The use of H₂ may be used but is not required. The use of H₂ may require additional safety measures to be implemented in view of the explosion hazard it presents. Dopant, such as Methanol (MeOH), acetonitrile (ACN), dichloromethane (DCM), carbon disulfide (CS₂), etc., can be added to the make up gas flow to control sensitivity/specificity. Alternatively or additionally, in some cases, a catalyst or compound can be added to prevent ionization of a certain compound in a certain class for selectivity purposes.

Ions generated in the reaction chamber 60 pass through the outlet 65 of the reaction chamber 60 and are attracted to the collector 70, which is also maintained at a pressure approximately equal to atmospheric pressure, while the remaining gases are passed through the exhaust 72 of the collector 70. The collision of ions into the collector 70 induces a current, which can be measured (e.g., using a virtual ground (op-amp current-to-voltage converter) and a voltage measuring instrument) and a corresponding signal delivered to a computing system for analysis and display. Generally, the measured data is integrated and displayed as the total ion current over time.

Other Implementations

Although a few implementations have been described in detail above, other modifications are possible. For example, in some implementations, the polarity of the corona pin is switched rapidly (e.g., every 20 milliseconds or a 50 Hz switching frequency), which can allow for the detection of a wider range of analytes.

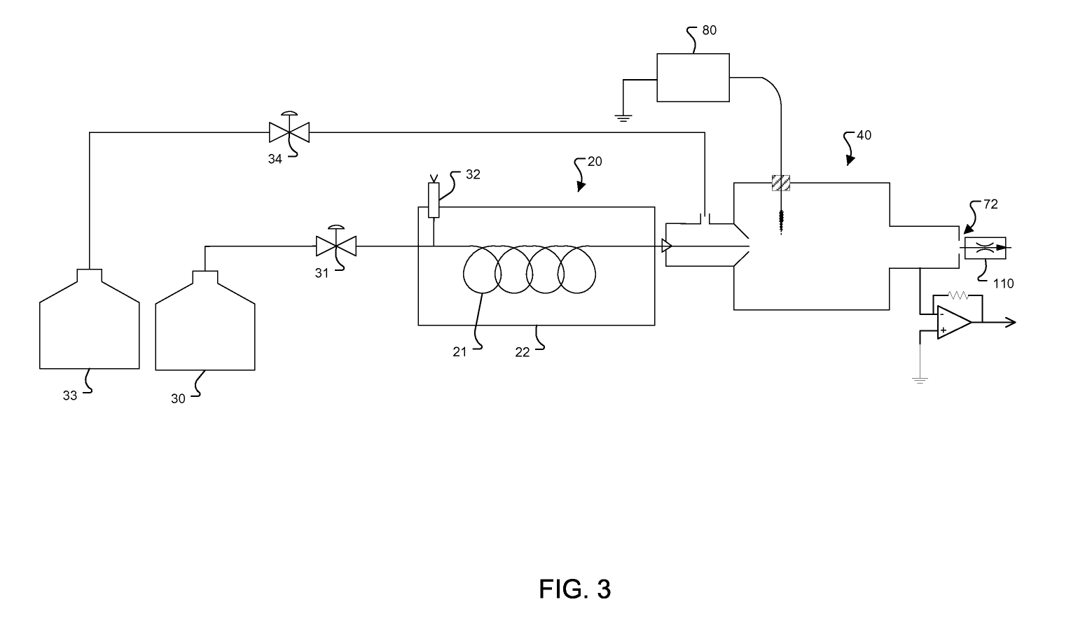

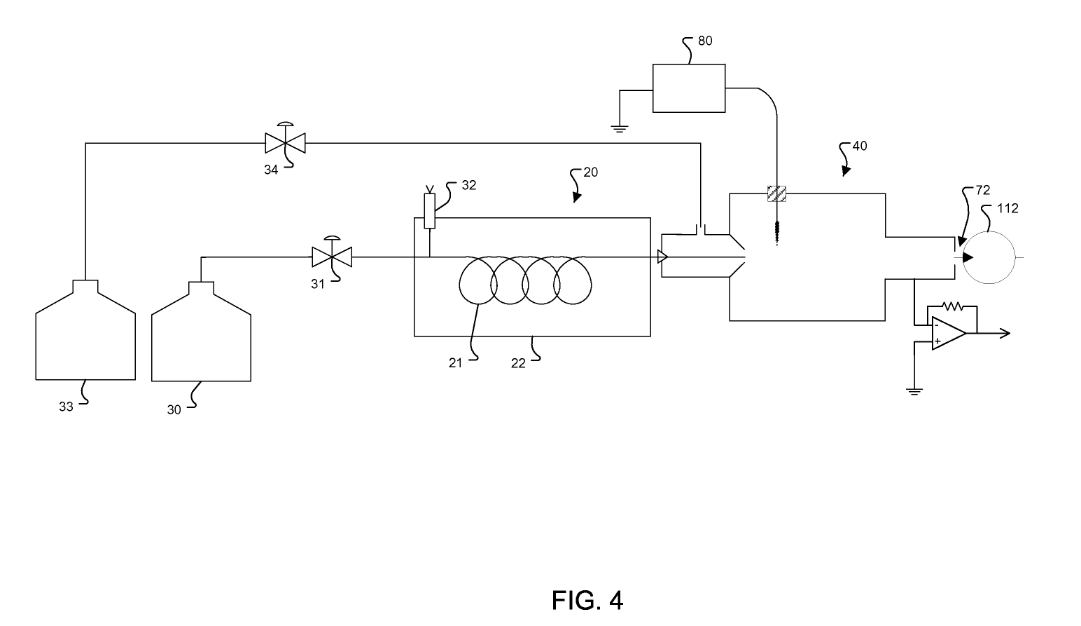

Referring to FIGS. 3 and 4, some implementations may include a variable flow restrictor 110 (FIG. 3) or a pump 112 (FIG. 4) disposed at the exhaust 72 of the collector 70 for controlling pressure and/or gas concentration in the reaction chamber 60.

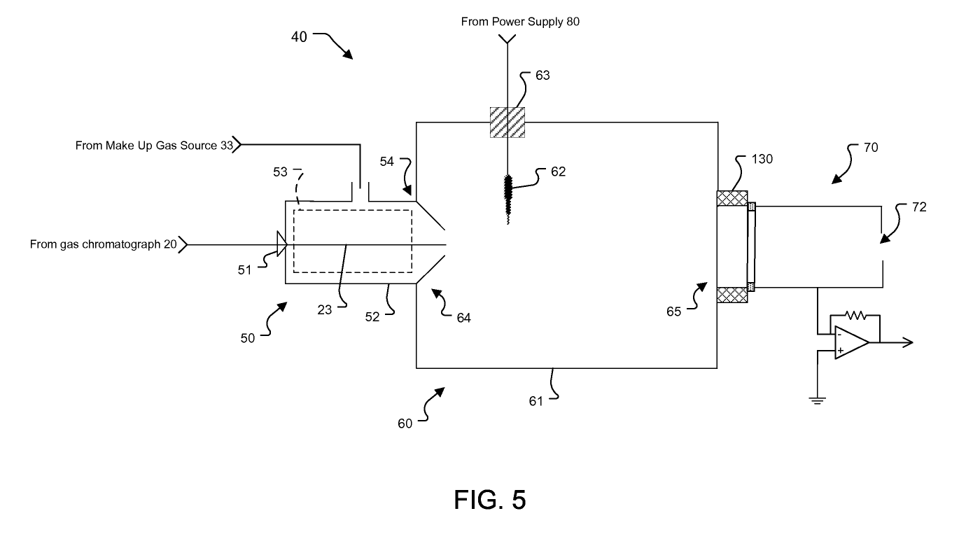

With reference to FIG. 5, some implementations may include a filter element 130 between the reaction chamber 60 and the collector 70 to reduce low mass chemical noise, since the collector 70 is an indiscriminant collector of ionized species from the reaction chamber 60. The filter element 130 could be in the form of magnetic fields/magnets, an RF ion guide, an ion gate (DC), or an IMS (ion-mobility spectrometry) sector. In some cases, for example, permanent magnets could be utilized to steer low masses away from the collector.

While implementations have been described in which separate gas flows are provided for the carrier and make up gases, in some implementations, a single gas source may provide both the carrier gas and the make up gas. For example, N₂ can be used as the carrier gas as well as the make up gas, thereby allowing a single N₂ source to be used for the GC column and the detector.

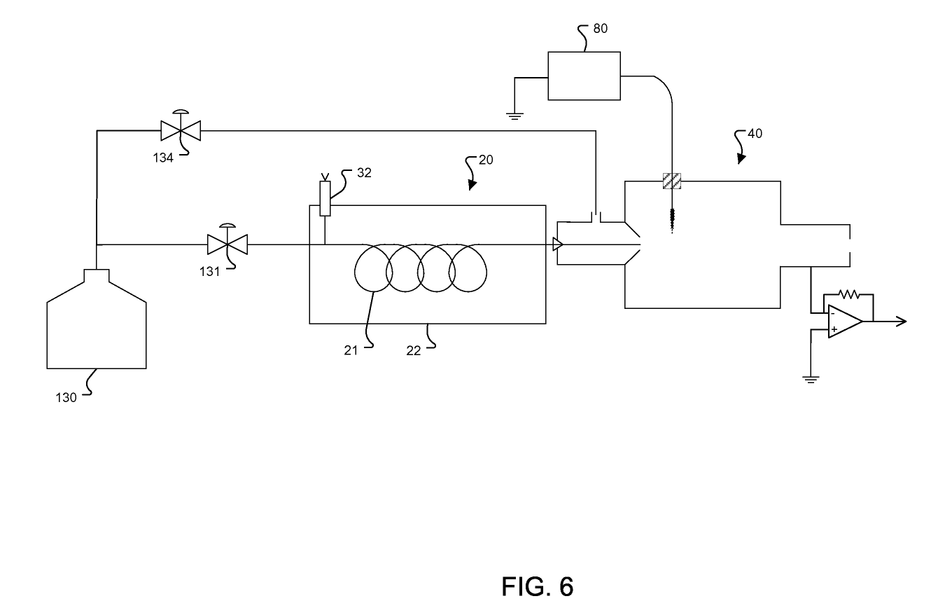

FIG. 6 illustrates an implementation in which a single gas source 130 provides both the carrier gas and the make up gas, which are controlled via separate flow controllers 131, 134.

In some cases, the make up gas promotes chemical reaction without ionization. For example, in some cases, a make up gas may be utilized to remove certain chromatographic peaks.

Certain implementations may include a grounded electrical shield surrounding (as much as possible) the reaction chamber. This could help to shield the chamber from ambient electrical interference.

While implementations have been described in which an atmospheric pressure chemical ionization detector (APCID) ionizes and detects analytes eluting from a gas chromatography column, in some implementations gas phase analytes may be introduced into the APCID, for ionization and detection, directly without chromatography.

Although implementations have been described in which an atmospheric pressure chemical ionization detector (APCID) is incorporated in a gas chromatography system, in some implementations, the APCID may alternatively be incorporated in a supercritical fluid chromatography (SFC) system, such that the APCID ionizes and detects analytes eluting from an SFC column. In such cases, an inlet tube that is either integral with, or is connected to, an outlet of an SFC column extends into the base of the APCID for delivering effluent. As in the case of the GC system, the base of the APCID can connect to the inlet tube via a standard fitting to seal the inlet tube to the APCID.

Accordingly, other implementations are within the scope of the following claims.

What is claimed is:

1. An atmospheric pressure chemical ionization detector comprising:
a reaction chamber configured to receive gas phase analytes;
an electrode disposed within the reaction chamber and configured to ionize the gas phase analytes via corona discharge; and
a collector disposed adjacent an outlet of the reaction chamber and configured to attract ions from the chamber such that the ions hit the collector to induce a measurable current,
wherein the detector is configured for non-mass spectrometric detection of gas phase analyte ions.

2. The detector of claim 1, further comprising a base disposed upstream of the reaction chamber and configured to direct a flow of a make up gas towards the reaction chamber.

3. The detector of claim 2, wherein the base is integrally connected to the reaction chamber.

4. The detector of claim 2, wherein the base includes a heater for heating the effluent from the gas chromatography column.

5. The detector of claim 2, wherein the base is configured to be connected to an inlet tube for delivering effluent, containing the gas phase analytes, from a gas chromatography column.

6. The detector of claim 1, wherein the electrode is mounted through a wall of the housing with an insulator.

7. The detector of claim 1, wherein the collector comprises a cylindrical electrode.

8. The detector of claim 1, wherein the collector includes an exhaust port for venting neutral molecules.

9. The detector of claim 8, further comprising a variable restrictor or a pump in communication with the exhaust port for controlling pressure and/or gas concentration within the detector.

10. The detector of claim 1, wherein the detector is configured to measure cumulative ion intensity (rather than individual ion intensities).

11. The detector of claim 1, wherein the detector is sensitive to the mass of ions (rather than the concentration of ions), such that the detector is not greatly affected by changes in carrier gas flow rate.

12. A method comprising:
passing a flow of a first gas carrying a sample through a gas chromatograph;
merging a flow of a second gas with effluent from the gas chromatograph to provide a mixed gas flow;
generating ions by passing the mixed gas flow through a corona discharge; and
measuring a cumulative ion intensity of the generated ions without passing the ions through a mass analyzer.

13. The method of claim 12, wherein the steps of generating ions and measuring a current are performed at a pressure approximately equal to atmospheric pressure.

14. The method of claim 12, further comprising heating the effluent to a temperature of about 50° C. to about 400° C.

15. The method of claim 12, wherein measuring a cumulative ion intensity comprises measuring a current induced by ions hitting a collector electrode.

16. The method of claim 12, wherein measuring a cumulative ion intensity comprises measuring a total current of ions generated.

17. The method of claim 12, further comprising rapidly switching polarity of a corona pin generating the corona discharge, thereby to detect ions having opposite polarities.

18. The method of claim 17, wherein the polarity of the corona pin is switched at a frequency of about 50 Hz.

19. The method of claim 12, wherein the corona discharge is provided by a corona pin disposed within a reaction chamber.

20. A method comprising:
passing a flow of a first gas carrying a sample through a gas chromatograph;
merging a flow of a second gas with effluent from the gas chromatograph to provide a mixed gas flow;
generating ions by passing the mixed gas flow through a corona discharge; and
measuring a cumulative ion intensity of the generated ions without separating the ions according to their respective mass-to-charge ratios.

21. A method comprising:
passing a flow of a first gas carrying a sample through a gas chromatograph;
merging a flow of a second gas with effluent from the gas chromatograph to provide a mixed gas flow;
generating ions by passing the mixed gas flow through a corona discharge; and
performing non-mass spectrometric detection of the generated ions.
